(19) United States
(12) Patent Application Publication
(10) Pub. No.: US 2024/0409466 A1
(43) Pub. Date: Dec. 12, 2024

(54) HIGH DENSITY WASHABLE MINING GROUTING REINFORCEMENT MATERIAL AND PREPARATION METHOD THEREOF

(71) Applicant: CCRI (Beijing) New Material Technology Co., Ltd., Beijing (CN)

(72) Inventors: Xiaofeng Yu, Beijing (CN); Enqing Xie, Beijing (CN); Gang Sun, Beijing (CN); Yuchao Wang, Beijing (CN); Dong Shen, Beijing (CN); Mingkun Zhang, Beijing (CN); Kai Wang, Beijing (CN); Chaohe Hu, Beijing (CN); Guangfeng Bai, Beijing (CN); Dezhi Zhang, Beijing (CN); Yifang Liu, Beijing (CN); Weihua Liu, Beijing (CN)

(21) Appl. No.: 18/671,550

(22) Filed: May 22, 2024

(30) Foreign Application Priority Data
Jun. 7, 2023 (CN) 2023106683186

(51) Int. Cl. C04B 28/26; C04B 14/04; C04B 14/36; C04B 16/04; C04B 40/00; C04B 103/00; C04B 103/30; C04B 111/00; C04B 111/70

(52) U.S. Cl. CPC C04B 28/26; C04B 14/045; C04B 14/368; C04B 16/04; C04B 40/0046; C04B 2103/0067; C04B 2103/0091; C04B 2103/30; C04B 2111/00724; C04B 2111/70; C04B 2201/50

(57) ABSTRACT

A mining grouting reinforcement material is provided and includes a component A including a sodium silicate solution and an amino acid salt, and a component B including an isocyanate, a plasticizer, a filler and a molecular bridging agent. A specific gravity of the filler is 2 to 8.

### CROSS-REFERENCE TO RELATED APPLICATION

This application claims priority to and benefits of Chinese Patent Application No. 202310668318.6, filed with the China National Intellectual Property Administration on Jun. 7, 2023, the contents of which are incorporated herein by reference in their entireties for all purposes.

### FIELD

The present disclosure relates to the technical field of grouting reinforcement of coal mining working faces, and more particularly to a mining grouting reinforcement material capable of being efficiently washed and selected and a preparation method thereof.

### BACKGROUND

With the depletion of shallow coal seams in coal mines, coal mining has entered a stage of deep mining. Geological conditions of a coal and rock mass in deep coal mines are complex, and there are many disasters in a coal mining process, such as rock burst disasters, coal and gas outburst disasters, sudden water inrush disasters and roof caving and spalling disasters. Especially, a geological coal and rock mass of a deep coal mining working face is fragmented to a great extent, and affected by “three highs and one disturbance,” the roof caving and spalling disasters occur frequently in the working face, which not only significantly reduces the coal mining efficiency, but also seriously threatens the safety of underground miners and devices. For the coal and rock mass with a large degree of fragmentation, it is difficult for a single anchor rod and cable to exert its anchoring force, which is inconsistent with temporary treatment goals of rapid advancement. After years of engineering practice and the development of new materials, grouting reinforcement may effectively solve the above-mentioned problems and has become an effective means to control the problem of the roof caving and spalling in the mining working faces.

There are many types of grouting reinforcement materials, which may be simply divided into three categories according to their chemical properties: inorganic, organic and organic-inorganic composite. In the field of coal mines, the most widely used grouting materials are: cement (or modified cement), polymers and inorganic modified polymers. Polymer and modified polymer materials are mainly used to prevent or control roof caving and spalling accidents in the coal mining working faces, especially polyurethane grouting reinforcement materials and silicate modified polyurethane grouting reinforcement materials. A silicate modified polyurethane material overcomes shortcomings of a polyurethane material and has outstanding advantages of low cost and high safety, and has become a most widely used chemical grouting material.

Although injecting this type of material may effectively solve a safety problem of the working face, it brings new problems to a subsequent washing process. Since the silicate modified polyurethane material contains more than half of silicate, a large amount of grouting may easily lead to an increase in an ash content of clean coal after washing and selected. Since a specific gravity of a silicate modified polyurethane consolidation is lower than that of a coal mass, it is very difficult to wash reinforcement materials out of the coal mass based on an existing washing and selected process and a coal washing principle of coal washing plant. This obviously increases the ash content of clean coal and seriously reduces the quality of clean coal.

Based on actual needs of coal mines and coal washing plants, there is an urgent need for a mining grouting reinforcement material capable of being efficiently washed and selected, which not only has advantages of low reaction temperature, high mechanical strength and good reinforcement effect, but also is capable of being efficiently washed and selected without affecting the quality of clean coal.

### SUMMARY

According to an aspect of the present disclosure, there is provided a mining grouting reinforcement material capable of being efficiently washed and selected. The mining grouting reinforcement material includes a component A and a component B. The component A includes a sodium silicate solution and an amino acid salt. The component B includes an isocyanate, a plasticizer, a filler and a molecular bridging agent. A specific gravity of the filler is 2 to 8. The amino acid salt includes at least one of amino acid salts containing all groups —COOH, —NH₂ and —COOR, where R is a metal ion.

According to another aspect of the present disclosure, there is further provided a method for preparing a mining grouting reinforcement material capable of being efficiently washed and selected. The method includes steps as follows. An amino acid salt is mixed with a sodium silicate solution uniformly to obtain a component A. Part of a plasticizer is mixed with a filler uniformly to obtain an admixture, then a molecular bridging agent is added into the admixture, and the molecular bridging agent and the admixture are mixed uniformly under a condition of sealing and first stirring to obtain a first mixture. A rest of the plasticizer is added into the first mixture to obtain a second mixture. An isocyanate is added into the second mixture under a condition of second stirring, followed by standing and storing in a sealed manner to obtain a component B. A specific gravity of the filler is 2 to 8. The amino acid salt includes at least one of amino acid salts containing all groups —COOH, —NH₂ and —COOR, where R is a metal ion.

Additional aspects and advantages of the present disclosure will be given in part in the following description, become apparent in part from the following description, or be learned by practice of the present disclosure.

### BRIEF DESCRIPTION OF THE DRAWINGS

The above-mentioned and/or additional aspects and advantages of the present disclosure will be apparent and readily understood from the following description of embodiments taken in conjunction with the accompanying drawings.

FIG. 1 is a schematic diagram showing an action mechanism of an amino acid salt in a mining grouting reinforcement material capable of being efficiently washed and selected provided in embodiments of the present disclosure, in which the amino acid salt takes the amino acid salt represented by formula (I) as an example, where 1 (wavy line) represents a polymer chain formed after the polymerization of organic components (that is, carbamate or substituted urea generated by the reaction of an isocyanate with water in a silicate solution).

FIG. 2 is a schematic diagram showing an action mechanism of a molecular bridging agent in a mining grouting reinforcement material capable of being efficiently washed and selected provided in embodiments of the present disclosure, in which the molecular bridging agent takes 3-[2-(2-aminoethylamino)ethylamino]propyl-trimethoxysilane (formula (II)) as an example. (a) A filler coated with a molecular bridging agent, where 2 represents the filler and 3 represents the molecular bridging agent. (b) The filler coated with the molecular bridging agent is combined with an organic compound, where 1 (wavy line) represents a polymer chain formed after the polymerization of organic components (that is, carbamate or substituted urea generated by a reaction between an isocyanate and water in a silicate solution), 2 represents the filler and 3 represents the molecular bridging agent.

### DETAILED DESCRIPTION

Embodiments of the present disclosure are described in detail below. The embodiments are illustrative, and are intended to explain the present disclosure and cannot be construed as limiting the present disclosure.

In the present disclosure, disclosure of numerical ranges includes disclosure of all values within the whole range and of further subdivided ranges, including endpoints and subranges given for those ranges.

In the present disclosure, raw materials and devices involved, unless otherwise specified, are all self-made raw materials and devices through commercial channels or known methods. Unless otherwise specified, the methods involved are all conventional methods.

The applicant found that in order to ensure that a grouting material is capable of being efficiently washed and selected and has characteristics of low reaction temperature and high mechanical strength, based on a coal washing process and a washing and selecting principle, the purpose of washout may be achieved by increasing a specific gravity of a consolidation of a reinforcement material. A simplest idea is to add a filler with a larger specific gravity. However, the following problems may also exist when adding the filler with the larger specific gravity:
1) The system balance of grouting materials is broken, the stability of grouting materials is greatly reduced and abnormal solidification is extremely prone to occur.
2) Large particle fillers are prone to cause stress concentration and a steep decline in mechanical properties. Small particle fillers are prone to agglomerate and sink, making grouting difficult.
3) The addition of a filler with a large specific gravity hinders the interfacial compatibility between an organic component (a composition when a component B of the present disclosure does not contain a molecular bridging agent) and an inorganic component (a composition when a component A of the present disclosure does not contain an amino acid salt).

Therefore, in order to overcome the above-mentioned defects, the applicant found that, based on a molecular bridging technology, ultra-fine substances with a large specific gravity may be evenly grafted into organic components and inorganic components, which may solve problems, such as instability, stress concentration and agglomeration decrease of grouting material system, and may significantly improve a specific gravity of the consolidation. Therefore, the above-mentioned defects caused by simply adding the filler with the large specific gravity may be overcome, and the mining grouting reinforcement material capable of being efficiently washed and selected and having characteristics of low reaction temperature, high mechanical strength and the like may be obtained.

In embodiments of the present disclosure, the mining grouting reinforcement material capable of being efficiently washed and selected includes a component A and a component B.

In some embodiments, the component A includes a sodium silicate solution and an amino acid salt.

In the embodiments of the present disclosure, the component A adopts the sodium silicate solution and the amino acid salt as raw materials. The amino acid salt has functions of catalyzing, stabilizing a system and promoting fusion. The type of amino acid salt is not limited in the present disclosure, as long as the amino acid salt includes at least one of amino acid salts containing all groups —COOH, —NH₂ and —COOR (where R is a metal ion). In a non-limiting example, the amino acid salt includes, but is not limited to, at least one of amino acid salts containing all groups —COOH, —NH₂ and —COOR (where R is a sodium ion or a potassium ion), such as a sodium glutamate, an amino acid salt represented by formula (I), a sodium lauroylglutamate, a potassium cocoyl glycinate, a sodium palmitoyl sarcosinate, a sodium cocoyl glycinate, a TEA-cocoyl glutamate, etc.

Taking an amino acid salt represented by formula (I) as an example, a structure of the amino acid salt provided in the present disclosure, functions of functional groups of the amino acid salt and an action mechanism of an amino acid salt in a mining grouting reinforcement material capable of being efficiently washed and selected provided in embodiments of the present disclosure are illustrated below.

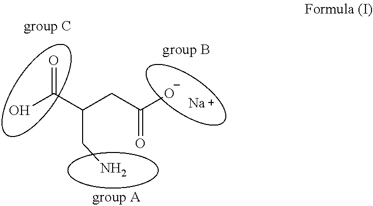

A group A (the above-mentioned —NH₂) may be used as a catalytic active site for a reaction, solidification and coagulation of the component A and the component B to realize a catalytic function (that is, the group A has the catalytic function). A group B (the above-mentioned —COOR (where R is a sodium ion)) bridges an inorganic component (hereinafter referred to as a molecular bridging agent of the component B). A group C (the above-mentioned —COOH) bridges an organic component (hereinafter referred to as an isocyanate of the component B). Three functional groups of the group A, the group B and the group C act together to achieve catalysis, stabilization and promotion fusion.

It is to be noted that the formula (I) is only an example of the amino acid salt in the embodiments of the present disclosure, which aims to illustrate that the structure of the amino acid salt in the embodiments of the present disclosure is an amino acid salt containing all groups —COOH (the group C), —NH₂ (the group A) and —COOR (where R is a metal ion) (the group B), and cannot be understood as the only restriction on the amino acid salt in the embodiments of the present disclosure. The group A, the group B and the group C are artificial definitions only for convenience.

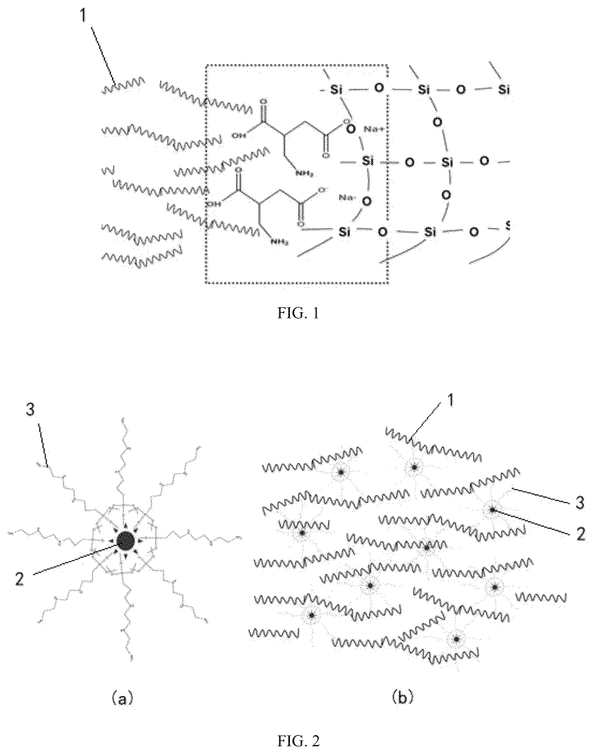

FIG. 1 is a schematic diagram showing an action mechanism of an amino acid salt in a mining grouting reinforcement material capable of being efficiently washed and selected provided in embodiments of the present disclosure. Reference to FIG. 1, it may be seen that the action mechanism of the amino acid salt in the mining grouting reinforcement material capable of being efficiently washed and selected provided in the embodiments of the present disclosure is that after two components of grouting materials are mixed, the amino acid salt acts on a phase interface between the organic component and the inorganic component, and the group A acts as the catalytic active site to trigger a reaction between the isocyanate and water in the sodium silicate solution to produce a high molecular polymer (an organic phase), which is accompanied by the release of CO₂, and the CO₂ reacts with the sodium silicate to generate a silicic acid polymer (an inorganic phase). At this time, according to a principle of similarity and compatibility, the group C interacts with the organic phase and the group B interacts with the inorganic phase to promote the mutual compatibility of the components and stabilization of an overall reaction.

In some embodiments, in the component A, a mass ratio of the sodium silicate solution to the amino acid salt is (90-95):(2-6), including but not limited to 90:2, 90:6, 95:2, 95:6 or 92.5:4, etc.

In some embodiments, the sodium silicate solution has a modulus of 2.4-2.8, and a Baume degree of 40-50° Be. In a non-limiting example, the modulus of sodium silicate solution includes, but is not limited to 2.4, 2.5, 2.6, 2.7 or 2.8, etc., and the Baume degree includes, but is not limited to 40° Bé, 45° Bé or 50° Bé, etc.

In some embodiments, a component B includes an isocyanate, a plasticizer, a filler and a molecular bridging agent. The filler is a filler with a large specific gravity.

In some embodiments, a specific gravity of the filler is 2 to 8 mg/m³, including but not limited to 2 mg/m³, 4 mg/m³, 5 mg/m³, 6 mg/m³ or 8 mg/m³, etc. When specific gravity of the filler is within the above-mentioned range, it is possible to achieve the objective of increasing the specific gravity while maintaining the stability of the system. When the specific gravity is less than 2 mg/m³, the increase in the specific gravity of the system is not obvious. When specific gravity is more than 8 mg/m³, the stability of the system is poor.

It is to be noted that, in the embodiments of the present disclosure, the filler may be an inorganic filler or an organic filler, as long as the specific gravity is 2 to 8 mg/m³. In the embodiments of the present disclosure, the filler with the large specific gravity is inert and does not participate in the chemical reaction of the system, so the addition of such substances may indirectly reduce a content of active substances, thus reducing the heat release of the reaction. At the same time, this type of filler has characteristics of flame retardancy and strong rigidity, which may further improve the flame retardancy and mechanical strength of the grouting materials.

In a non-limiting example, the filler includes at least one of barite powders, galena powders or iron ore powders.

In some embodiments, the molecular bridging agent includes at least one of an amino-containing silane coupling agent or a N-(triethoxysilylpropyl) urea (CAS: 23779-32-0). The amino-containing silane coupling agent includes, but is not limited to at least one of 3-[2-(2-aminoethylamino)ethylamino]propyl-trimethoxysilane (CAS: 35141-30-1) or N-[3-(trimethoxysilyl) propyl]ethylenediamine (CAS: 1760-24-3). A structural formula of the 3-[2-(2-aminoethylamino)ethylamino]propyl-trimethoxysilane is shown in formula (II). A structural formula of the N-[3-(trimethoxysilyl) propyl]ethylenediamine is shown in formula (III). A structural formula of the N-(triethoxysilylpropyl) urea is shown in formula (IV).

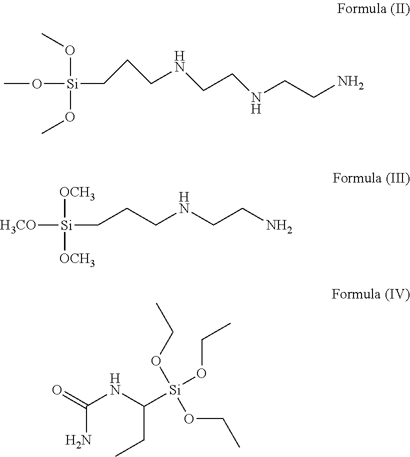 [SMILES: CO[Si](CCCNCCNCCN)(OC)OC ; CO[Si](CCCNCCN)(OC)OC ; CCO[Si](OCC)(OCC)C(CC)NC(N)=O]

In the mining grouting reinforcement material capable of being efficiently washed and selected provided in embodiments of the present disclosure, the component B introduces the molecular bridging agent, and the filler with a large specific gravity and a small size is bridged to the polymer chain, so as to avoid stress concentration, agglomeration and sinking of the filler.

FIG. 2 is a schematic diagram showing an action mechanism of a molecular bridging agent in a mining grouting reinforcement material capable of being efficiently washed and selected provided in embodiments of the present disclosure, in which the molecular bridging agent takes 3-[2-(2-aminoethylamino)ethylamino]propyl-trimethoxysilane (formula (II)) as an example. Referring to FIG. 2, in the embodiments of the present disclosure, the action mechanism of the molecular bridging agent is mainly as follows: through van der Waals forces and electrostatic forces, the molecular bridging agent forms a stable adsorption layer and is coated on a surface of a filler with a large specific gravity. However, a long carbon chain and an amino group in a structure of the molecular bridging agent undergoes a condensation reaction with a NCO group in the isocyanate, thus combining the filler with the large specific gravity and an organic polymer to achieve bridging effect.

In some embodiments, the isocyanate includes at least one of a polyphenyl polymethylene polyisocyanate (PAPI) or a diphenylmethane diisocyanate (MDI-50).

In some embodiments, the plasticizer includes at least one of triethyl citrate, chloromethyl palmitate or tributyl phosphate.

In some embodiments, in the component B, a mass ratio of the isocyanate, the plasticizer, the filler and the molecular bridging agent is (60-80):(5-30):(10-15):(1-5), including but not limited to 60:5:10:1, 60:30:10:1, 60:30:15:1, 60:30:15:15, 80:30:15:5, 80:5:10:1, 80:5:15:1, 80:5:15:15, 80:30:10:1, 80:30:10:5 or 70:18:12:2.5, etc.

In some embodiments, a volume ratio of the component A and the component B is (0.85-1.15):1. In an non-limiting example, the volume ratio of the component A and the component B includes, but is not limited to 0.85:1, 0.9:1, 1:1, 1.1:1 or 1.15:1, etc. When the volume ratio of the component A and the component B is within the above-mentioned range, a slurry may be solidified stably, and comprehensive properties of a consolidation are excellent. In case that the volume ratio is less than 0.85:1, the heat released in a slurry reaction is greater, and the risk of coal mine grouting is greater. When the volume ratio is greater than 1.15:1, mechanical properties of the material will decrease significantly after the slurry is solidified.

A method for preparing a mining grouting reinforcement material capable of being efficiently washed and selected provided in embodiments of the present disclosure includes steps as follows.

In S101, a component A is prepared. An amino acid salt is mixed with a sodium silicate solution uniformly to obtain the component A.

In S102, a component B is prepared. The preparation of the component B include steps as follows.

(1) Part of a plasticizer is mixed with a filler uniformly to obtain an admixture, then a molecular bridging agent is added into the admixture, and the molecular bridging agent and the admixture are mixed uniformly under a condition of first temperature, sealing and first stirring to obtain a first mixture.

In some embodiments, based on a total mass of the plasticizer, a proportion of the plasticizer mixed with the filler includes, but is not limited to 5 to 50%, such as 10%, 20%, 30%, 40% or 50%, etc.

In some embodiments, the first temperature is 30 to 50° C., including but not limited to 30° C., 40° C. or 50° C., etc.

In some embodiments, a time for the first stirring is 30 to 40 min, including but not limited to 30 min, 35 min, or 40 min, etc.

(2) A rest of the plasticizer is added into the first mixture to obtain a second mixture.

(3) An isocyanate is slowly added into the second mixture under a condition of second stirring, followed by standing and storing in a sealed manner to obtain a component B.

It is to be noted that stirring speeds of the first stirring and the second stirring may be the same or different, and are generally 300 to 500 r/min.

In S103, the component A and the component B are mixed at a volume ratio of 0.85 to 1.15:1, and injected into cracks of a coal and rock mass via a grouting pump.

Based on a molecular bridging technology, the filler with the large specific gravity is grafted into an organic isocyanate component, which may not only significantly increase a specific gravity of a consolidation of the mining grouting reinforcement material, but also may avoid surface filler agglomeration and stress concentration. The amino acid salt may improve the system stability of the mining grouting reinforcement material, and finally, the mining grouting reinforcement material is capable of being efficiently washed and selected by a coal washing plant, with a washout rate more than 99%.

Since the mining grouting reinforcement material provided in the present disclosure is capable of being efficiently washed and selected, after injecting it into a coal mining working face, it has almost no adverse influence on ash, volatile matter, calorific value and total sulfur of coal quality.

With a composition design of the component A and the component B, the maximum reaction temperature and heat released in a grouting and solidification process of the mining grouting reinforcement material are significantly reduced, the flame retardancy is good, the mechanical strength is high, and the safety of coal mine grouting is greatly improved especially when reinforcing coal seams prone to spontaneous combustion.

Some features of this technology are further illustrated in the following non-limiting examples.

First, Examples and Comparative Examples

### Example 1

A mining grouting reinforcement material capable of being efficiently washed and selected in this example includes a component A and a component B, and a volume ratio of the component A and the component B is 0.98:1.

The component A includes 95 g of a sodium silicate solution and 3 g of an amino acid salt. The sodium silicate solution has a modulus of 2.6, and a Baume degree of 45° Bé. The amino acid salt is a sodium salt of an amino acid with a structure of the above-mentioned formula (I).

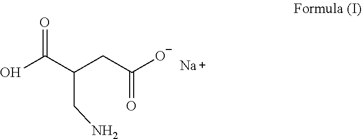

The component B includes 60 g of an isocyanate (PAPI), 25 g of a plasticizer (13 g of a triethyl citrate, 12 g of a chloromethyl palmitate), 13 g of a filler with a large specific gravity (8 g of barite powders and 5 g of galena powders) and 2 g of molecular bridging agent (1 g of 3-[2-(2-aminoethylamino)ethylamino]propyl-trimethoxysilane, 1 g of N-[3-(trimethoxysilyl) propyl]ethylenediamine).

A method for preparing a mining grouting reinforcement material capable of being efficiently washed and selected in this example includes steps as follows.

In S101, a component A is prepared. An amino acid salt is mixed with a sodium silicate solution uniformly to obtain the component A.

In S102, a component B is prepared. The preparation of the component B include steps as follows.

(1) A half of a plasticizer is mixed with a filler uniformly to obtain an admixture, then a molecular bridging agent is added into the admixture, and the molecular bridging agent and the admixture are mixed uniformly under the condition of sealing and stirring at 40° C. for 40 min (a stirring speed is 400 r/min) to obtain a first mixture.

(2) A rest of the plasticizer is added into the first mixture to obtain a second mixture.

(3) An isocyanate is slowly added into the second mixture under the condition of stirring (a stirring speed is 400 r/min), followed by standing and storing in a sealed manner to obtain a component B.

In S103, the component A and the component B are mixed at a volume ratio of 0.98:1, and injected into cracks of a coal and rock mass via a grouting pump.

### Example 2

This example is basically the same as Example 1, except that in the component A, an amount of the amino acid salt is 6 g. The volume ratio of the component A and the component B is 1.01:1.

### Example 3

This example is basically the same as Example 1, except that in the component A, the amino acid salt is a mixture of a sodium salt of an amino acid with a structure of formula (I) and a sodium glutamate in a mass ratio of 1:1.

### Example 4

This example is basically the same as Example 1, except that in the component B, an amount of the filler with the large specific gravity is 10 g, a mass ratio of the barite powders to the galena powders remains unchanged, and the volume ratio of the component A and the component B is 1.01:1.

### Example 5

This example is basically the same as Example 1, except that in the component B, an amount of the filler with the large specific gravity is 15 g, a mass ratio of the barite powders to the galena powders remains unchanged, and the volume ratio of the component A and the component B is 1.01:1.

### Example 6

This example is basically the same as Example 1, except that in the component B, all fillers with a large specific gravity are the barite powders.

### Example 7

This example is basically the same as Example 1, except that in the component B, all the fillers with a large specific gravity are the galena powders.

### Example 8

This example is basically the same as Example 1, except that in the component B, an amount of the molecular bridging agent is 5 g, a mass ratio of 3-[2-(2-aminoethylamino)ethylamino]propyl-trimethoxysilane to N-[3-(trimethoxysilyl) propyl]ethylenediamine remains unchanged, and the volume ratio of the component A and the component B is 0.95:1.

### Example 9

This example is basically the same as Example 1, except that in the component B, an amount of the isocyanate is 75 g, and the volume ratio of the component A and the component B is 0.85:1.

### Example 10

This example is basically the same as Example 1, except that in the component B, an amount of the plasticizer is 12 g, a mass ratio of the triethyl citrate to the chloromethyl palmitate remains unchanged, and the volume ratio of the component A and the component B is 0.85:1.

### Comparative Example 1 (an Existing Conventional Mining Grouting Reinforcement Material)

A mining grouting reinforcement material of the comparative example includes a component A and a component B, and a volume ratio of the component A and the component B is 1:1.

The component A includes 95 g of a sodium silicate solution, 3 g of a triethylenediamine (TEDA) catalyst and 2 g of a glycerol. The sodium silicate solution has a modulus of 2.6 and a Baume degree of 45° Bé.

The component B includes 80 g of an isocyanate (PAPI) and 20 g of a plasticizer of a dioctyl phthalate (DOP).

A method for preparing a mining grouting reinforcement material capable of being efficiently washed and selected in this comparative example includes steps as follows.

In S101, a component A is prepared. A triethylenediamine (TEDA) catalyst and a glycerol are mixed with a sodium silicate solution uniformly to obtain the component A.

In S102, a component B is prepared. An isocyanate is mixed with a plasticizer of a dioctyl phthalate uniformly to obtain a component B.

In S103, the component A and the component B are mixed at a volume ratio of 1:1, and injected into cracks of a coal and rock mass via a grouting pump.

### Comparative Example 2 (without Adding an Amino Acid Salt and a Molecular Bridging Agent)

This comparative example is basically the same as Example 1, except that in the mining grouting reinforcement material, an amino acid salt in the component A is replaced with a triethylenediamine (TEDA) catalyst, and there is no molecular bridging agent in the component B, and the volume ratio of the component A and the component B is 1:1.

A method for preparing a mining grouting reinforcement material of this comparative example includes steps as follows.

In S101, a component A is prepared. A triethylenediamine (TEDA) catalyst is mixed with a sodium silicate solution uniformly to obtain the component A.

In S102, a component B is prepared. The preparation of the component B include steps as follows.

(1) A half of a plasticizer is mixed with a filler uniformly under the condition of sealing and stirring at 40° C. for 40 min (a stirring speed is 400 r/min) to obtain a first mixture.

(2) A rest of the plasticizer is added into the first mixture to obtain a second mixture.

(3) An isocyanate is slowly added into the second mixture under the condition of stirring (a stirring speed is 400 r/min), followed by standing and storing in a sealed manner to obtain a component B.

In S103, the component A and the component B are mixed at a volume ratio of 1:1, and injected into cracks of a coal and rock mass via a grouting pump.

### Comparative Example 3 (without Adding a Filler with a Large Specific Gravity)

This comparative example is basically the same as Example 1, except that in the mining grouting reinforcement material, there is no filler with the large specific gravity in the component B, and the volume ratio of the component A and the component B is 1.13:1.

A method for preparing a mining grouting reinforcement material of this comparative example includes steps as follows

A method for preparing a mining grouting reinforcement material capable of being efficiently washed and selected of this comparative example includes steps as follows.

In S101, a component A is prepared. An amino acid salt is mixed with a sodium silicate solution uniformly to obtain the component A.

In S102, a component B is prepared. The preparation of the component B include steps as follows.

(1) A half of a plasticizer is mixed with a molecular bridging agent uniformly under the condition of sealing and stirring at 40° C. for 40 min (a stirring speed is 400 r/min) to obtain a first mixture.

(2) A rest of the plasticizer is added into the first mixture to obtain a second mixture.

(3) An isocyanate is slowly added into the second mixture under the condition of stirring (a stirring speed is 400 r/min), followed by standing and storing in a sealed manner to obtain a component B.

In S103, the component A and the component B are mixed at a volume ratio of 0.98:1, and injected into cracks of a coal and rock mass via a grouting pump.

### Second, Performance Test

### 1. Performance Test Method

For a maximum reaction temperature, a compressive strength, a combustion condition, sample preparation and test methods, reference may be made to AQ/T 1089-2020 “Polymer Materials for Reinforcement of Coal and Rock Mass in Coal Mines”.

A test method of washout rate: a proportion of consolidation of a grouting material in a clean coal. For example, when the proportion is 1%, the washout rate is 99%.

For a test method of influence on an ash content of a clean coal, reference may be made to GB/T 212-2008 “Methods for Industrial Analysis of Coal”.

For a test method of influence on a caloric value of a clean coal, reference may be made to GB/T 213-2008 “Method for Determination of Calorific Value of Coal”.

### 2. Performance Test Results

Performance test results of a mining grouting reinforcement material in Examples and Comparative Examples may be seen in Table 1.

TABLE 1
Performance test results of a mining grouting reinforcement
material in Examples and Comparative Examples

| | | | | Combustion | | |
|---|---|---|---|---|---|---|
| | | | | condition | | |
| | | Maximum | | (alcohol | | Influence |
| | | reaction | | burner burns | Influence | on heat |
| | Washout | temperature/° | Compressive | continuously | on ash | of clean |
| Item | rate | C. | strength/MPa | for 20 s) | content | coal |
| Example 1 | 99.8% | 73 | 46 | non- | Almost | Almost |
| | | | | inflammable | no | no |
| | | | | | influence | influence |
| Example 2 | 99.8% | 72 | 48 | non- | Almost | Almost |
| | | | | inflammable | no | no |
| | | | | | influence | influence |
| Example 3 | 99.8% | 74 | 47 | non- | Almost | Almost |
| | | | | inflammable | no | no |
| | | | | | influence | influence |
| Example 4 | 99.3% | 74 | 46 | non- | Almost | Almost |
| | | | | inflammable | no | no |
| | | | | | influence | influence |
| Example 5 | 99.8% | 70 | 45 | non- | Almost | Almost |
| | | | | inflammable | no | no |
| | | | | | influence | influence |
| Example 6 | 99.85% | 72.5 | 45.5 | non- | Almost | Almost |
| | | | | inflammable | no | no |
| | | | | | influence | influence |
| Example 7 | 99.6% | 73.5 | 46.5 | non- | Almost | Almost |
| | | | | inflammable | no | no |
| | | | | | influence | influence |
| Example 8 | 99.8% | 72 | 49 | non- | Almost | Almost |
| | | | | inflammable | no | no |
| | | | | | influence | influence |
| Example 9 | 99.8% | 80 | 52 | non- | Almost | Almost |
| | | | | inflammable | no | no |
| | | | | | influence | influence |
| Example 10 | 99.8% | 78 | 49 | non- | Almost | Almost |
| | | | | inflammable | no | no |
| | | | | | influence | influence |
| Comparative | <10% | 115 | 45 | Burn for 5- | Increase | Lower |
| Example 1 | | | | 10 s after | in ash | the heat |
| | | | | leaving the | content | |
| | | | | fire | | |
| Comparative | 95% | 87 | 5 | non- | Slightly | Slightly |
| Example 2 | | | | inflammable | increase | lower the |
| | | | | | in ash | heat |
| | | | | | content | |
| Comparative | <10% | 95 | 38 | Burn for 5- | Increase | Lower |
| Example 3 | | | | 10 s after | in ash | the heat |
| | | | | leaving the | content | |
| | | | | fire | | |

It may be seen from Table 1 that, compared with the Comparative Examples, the amino acid salt, the molecular bridging agent and the filler with the large specific gravity in the mining grouting reinforcement material of Examples 1-10 of the present disclosure act synergistically, so that the grouting reinforcement material has advantages of high washout rate, low maximum reaction temperature, good compressive strength and combustion condition, and almost no influence on the ash content and heat of clean coal.

Comparing Example 1 and Example 9, it may be seen that, in the mining grouting reinforcement material of Example 9 of the present disclosure, the content of the isocyanate in the component B is increased. Although the washout rate and the combustion condition are unchanged, and there is almost no influence on the ash content and heat of clean coal, the maximum reaction temperature and high pressure strength are both increased, which may be due to the fact that a main reaction of the grouting reinforcement material in the present disclosure is a reaction of the isocyanate and water to form a high molecular polymer, whose structure is rigid, which is a main load-bearing body after a slurry is solidified, and the reaction is accompanied by the release of heat. Therefore, increasing the content of the isocyanate significantly increases the reaction temperature and the compressive strength.

Comparing Example 1 and Example 10, it may be seen that, in the mining grouting reinforcement material of Example 10 of the present disclosure, the content of the plasticizer in the component B is reduced. Although the washout rate and the combustion condition are unchanged, and there is almost no influence on the ash content and heat of clean coal, the maximum reaction temperature and high pressure strength are both increased, which may be due to the decrease in the content of the plasticizer in the component B in Example 10 compared with Example 1, which indirectly increases a proportion of the isocyanate in the system. A main reaction of the grouting reinforcement material in the present disclosure is a reaction of the isocyanate and water to form a high molecular polymer, whose structure is rigid, which is a main load-bearing body after a slurry is solidified, and the reaction is accompanied by the release of heat. Therefore, increasing the content of the isocyanate significantly increases the maximum reaction temperature and the compressive strength.

Comparing Example 1 and Comparative Example 1, it may be seen that, the washout rate of the mining grouting reinforcement material in Example 1 of the present disclosure is significantly higher than that of the conventional mining grouting reinforcement material (Comparative Example 1), the maximum reaction temperature is significantly reduced, the combustion condition is good, and there is almost no influence on the ash content and heat of clean coal.

Comparing Example 1 and Comparative Example 2, it may be seen that in case that both Example 1 and Comparative Example 2 include the filler with the high specific gravity, since Example 1 includes the amino acid salt and the molecular bridging agent, the washout rate and the compressive strength of the mining grouting reinforcement material of the example of the present disclosure are improved. The washout rate is close to 100% and the compressive strength is improved by about 8 times, the maximum reaction temperature is reduced by 19%, and there is almost no influence on ash and heat of clean coal.

Comparing Example 1 and Comparative Example 3, it may be seen that, in the case that both Example 1 and Comparative Example 3 include the amino acid salt and the molecular bridging agent, since the filler with the high specific gravity is added in Example 1, the washout rate of the mining grouting reinforcement material of the example of the present disclosure is increased by at least 8 times, the maximum reaction temperature is reduced by about 30%, the compressive strength is improved, the combustion condition is good, and there is almost no influence on the ash content and heat of clean coal.

Reference throughout the present disclosure to “an embodiment,” “some embodiments,” “an example,” “a specific example,” or “some examples,” mean that a particular feature, structure, material, or characteristic described in connection with the embodiment or example is included in at least one embodiment or example of the present disclosure. The schematic expressions of the above-mentioned terms throughout this specification are not necessarily referring to the same embodiment or example. Moreover, the particular features, structures, materials, or characteristics described may be combined in any suitable manner in one or more embodiments or examples. In addition, those skilled in the art can combine the different embodiments or examples and features of different embodiments or examples described in this specification without being mutually inconsistent.

Although the embodiments of the present disclosure have been shown and described above, it is to be understood that the above embodiments are illustrative and cannot be construed as limiting the present disclosure, and those skilled in the art may make changes, modifications, substitutions, and variations to the above-mentioned embodiments within the scope of the present disclosure.

What is claimed is:

1. A mining grouting reinforcement material, comprising:
a component A comprising a sodium silicate solution and an amino acid salt;
a component B comprising an isocyanate, a plasticizer, a filler and a molecular bridging agent;
wherein a specific gravity of the filler is 2 to 8;
wherein the amino acid salt comprises at least one of amino acid salts containing all groups —COOH, —NH₂ and —COOR, where R is a metal ion.

2. The mining grouting reinforcement material of claim 1, wherein the molecular bridging agent comprises at least one of an amino-containing silane coupling agent or a N-(triethoxysilylpropyl) urea.

3. The mining grouting reinforcement material of claim 2, wherein the amino-containing silane coupling agent comprises at least one of 3-[2-(2-aminoethylamino)ethylamino]propyl-trimethoxysilane or N-[3-(trimethoxysilyl) propyl]ethylenediamine.

4. The mining grouting reinforcement material of claim 1, wherein the filler comprises at least one of barite powders, galena powders or iron ore powders.

5. The mining grouting reinforcement material of claim 1, wherein in the component A, a mass ratio of the sodium silicate solution to the amino acid salt is (90-95):(2-6).

6. The mining grouting reinforcement material of claim 1, wherein in the component B, a mass ratio of the isocyanate, the plasticizer, the filler and the molecular bridging agent is (60-80):(5-30):(10-15):(1-5).

7. The mining grouting reinforcement material of claim 1, wherein the sodium silicate solution has a modulus of 2.4-2.8, and a Baume degree of 40-50° Bé.

8. The mining grouting reinforcement material of claim 1, wherein the isocyanate comprises at least one of a polyphenyl polymethylene polyisocyanate or a diphenylmethane diisocyanate.

9. The mining grouting reinforcement material of claim 1, wherein the plasticizer comprises at least one of triethyl citrate, chloromethyl palmitate or tributyl phosphate.

10. The mining grouting reinforcement material of claim 1, wherein a volume ratio of the component A and the component B is (0.85-1.15):1.

11. A method for preparing a mining grouting reinforcement material, comprising:
mixing an amino acid salt with a sodium silicate solution uniformly to obtain a component A;
mixing part of a plasticizer with a filler uniformly to obtain an admixture, then adding a molecular bridging agent into the admixture, and mixing the molecular bridging agent and the admixture uniformly under a condition of sealing and first stirring to obtain a first mixture;
adding a rest of the plasticizer into the first mixture to obtain a second mixture;
adding an isocyanate into the second mixture under a condition of second stirring, followed by standing and storing in a sealed manner to obtain a component B;
wherein a specific gravity of the filler is 2 to 8;
wherein the amino acid salt comprises at least one of amino acid salts containing all groups —COOH, —NH₂ and —COOR, where R is a metal ion.

12. The method for preparing the mining grouting reinforcement material of claim 11, wherein the molecular bridging agent comprises at least one of an amino-containing silane coupling agent or a N-(triethoxysilylpropyl) urea.

13. The method for preparing the mining grouting reinforcement material of claim 12, wherein the amino-containing silane coupling agent comprises at least one of 3-[2-(2-aminoethylamino)ethylamino]propyl-trimethoxysilane or N-[3-(trimethoxysilyl) propyl]ethylenediamine.

14. The method for preparing the mining grouting reinforcement material of claim 11, wherein the filler comprises at least one of barite powders, galena powders or iron ore powders.

15. The method for preparing the mining grouting reinforcement material of claim 11, wherein in the component A, a mass ratio of the sodium silicate solution to the amino acid salt is (90-95):(2-6).

16. The method for preparing the mining grouting reinforcement material of claim 11, wherein in the component B, a mass ratio of the isocyanate, the plasticizer, the filler and the molecular bridging agent is (60-80):(5-30):(10-15):(1-5).

17. The method for preparing the mining grouting reinforcement material of claim 11, wherein the sodium silicate solution has a modulus of 2.4-2.8, and a Baume degree of 40-50° Bé.

18. The method for preparing the mining grouting reinforcement material of claim 11, wherein the isocyanate comprises at least one of a polyphenyl polymethylene polyisocyanate or a diphenylmethane diisocyanate.

19. The method for preparing the mining grouting reinforcement material of claim 11, wherein the plasticizer comprises at least one of triethyl citrate, chloromethyl palmitate or tributyl phosphate.

20. The method for preparing the mining grouting reinforcement material of claim 11, wherein a volume ratio of the component A and the component B is (0.85-1.15): 1.
